(19) United States
(12) Patent Application Publication
(10) Pub. No.: US 2011/0056618 A1
(43) Pub. Date: Mar. 10, 2011

(54) METHOD OF MANUFACTURING RADIATION DETECTOR

(76) Inventor: Hiromichi Tonami, Kyoto-fu (JP)

(21) Appl. No.: 12/991,724

(22) PCT Filed: Jun. 5, 2008
(86) PCT No.: PCT/JP2008/060371

§ 371 Date: Nov. 9, 2010

(51) Int. Cl. B32B 37/24

(52) U.S. Cl. 156/242

(57) ABSTRACT

With this invention, a light guide is placed on a scintillator while an optical adhesive for forming the scintillator does not harden. Accordingly, a method of manufacturing a radiation detector may be provided in which the step of hardening the optical adhesive that joins scintillation counter crystals to one another and the step of optically coupling the scintillator and the light guide are performed en bloc. Accordingly, the radiation detector may be manufactured with no complicated process of forming the scintillator and the light guide individually and coupling them with the optical adhesive.

### TECHNICAL FIELD

This invention relates to a method of manufacturing a radiation detector having a scintillator, a light guide, and a light detector that are optically coupled to one another in turn.

### BACKGROUND ART

In medical fields, emission computed tomography (ECT: Emission Computed Tomography) apparatus is used that detects radiation (such as gamma rays) emitted from radiopharmaceutical that is administered to a subject and is localized to a site of interest for obtaining sectional images of the site of interest in the subject showing radiopharmaceutical distributions. Typical ECT apparatus includes, for example, a PET (Positron Emission Tomography) device and an SPECT (Single Photon Emission Computed Tomography) device.

A PET device will be described by way of example. The PET device has a radiation detector ring with block radiation detectors arranged in a ring shape. The detector ring is provided for surrounding a subject, and allows detection of radiation that is transmitted through the subject.

Such radiation detector arranged in the detector ring of the PET device is often equipped that allows position discrimination in a depth direction of a scintillator provided in the radiation detector for improved resolution. Particularly, such radiation detector is used, for example, in a PET device set for animals. FIG. 26 is a perspective view showing a configuration of a conventional radiation detector. Such radiation detector 50 has scintillation counter crystal layers 52A, 52B, 52C, and 52D in which scintillation counter crystals 51 of rectangular solid are accumulated in two dimensions, a light detector 53 with a function of position discrimination that detects fluorescence irradiated from each of the scintillation counter crystal layers 52A, 52B, 52C, and 52D, and a light guide 54 that receives fluorescence. Here, each of the scintillation counter crystal layers 52A, 52B, 52C, and 52D is laminated in a z-direction to form a scintillator 52 that converts incident radiation into fluorescence. The radiation detector 50 of such a configuration is disclosed in, for example, Patent Literature 1.

The conventional radiation detector 50 is manufactured by forming the scintillator 52, the light detector 53, and the light guide 54 individually, stacking them in series, and then adhering to one another. The scintillator 52 of the conventional configuration is manufactured by firstly arranging scintillation counter crystals 51 three-dimensionally, and then by penetrating a thermosetting resin into gaps between adjacent scintillation counter crystals 51 and heating the thermosetting resin for hardening. The manufactured scintillator 52 has a film excessive resin adhering on a surface thereof. This is to be removed after the thermosetting resin hardens.

The light guide 54 of the conventional configuration is manufactured by pouring the thermosetting resin into a mold having a rectangular recess, and then heating it. A meniscus appears on a surface of the liquid thermosetting resin with which the rectangular recess is filled. Thus, a surface of the light guide 54 that is optically coupled to the scintillator 52 is not flat merely by removing the mold from the light guide 54. Accordingly, the surface of the light guide 54 that receives fluorescence is ground and polished to form the light guide 54 capable of installation on the radiation detector 50.

Thereafter, the scintillator 52 and the light guide 54 are coupled via an optical adhesive. As noted above, the radiation detector 50 is manufactured. Here, the thermosetting resin used for the light guide 54 sometimes differs from that used for the scintillator 52. Accordingly, in the method of manufacturing the conventional radiation detector 50, the scintillator 52 and the light guide 54 are not manufactured collectively

[Patent Literature 1]

Japanese Patent Publication No. 2004-279057

### DISCLOSURE OF THE INVENTION

### Problem To Be Solved By the Invention

However, the method of manufacturing the conventional radiation detector has the following drawbacks. That is, the problem is that the method of manufacturing the conventional radiation detector has many numbers of processes, and thus is complicated. The scintillator and light guide in the conventional radiation detector is manufactured by hardening the different types of thermosetting resins. Thereafter, one surface of the light guide 54 that is ground and polished is contacted on one surface of the scintillator 52 with the excessive thermosetting resin already removed therefrom.

Where the step of hardening the thermosetting resins and the step of optically coupling the scintillator 52 and the light guide 54 may be performed en bloc with different types of thermosetting resins used for the scintillator 52 and the light guide 54, the step may be omitted such as a processing of one surface of the scintillator 52 or the light guide 54 and a processing of optically coupling to each other. As a result, manufacture efficiency of the radiation detector may be enhanced.

The number of the radiation detectors arranged in one piece of the radiation tomography apparatus is considerable, since the radiation detectors form a detector ring. Consequently, it becomes important to suppress manufacturing costs of the radiation detectors for provision of radiation tomography apparatus of low price.

This invention has been made regarding the state of the art noted above, and its object is to provide a method of manufacturing a radiation detector having suppressed number of steps in which a step of hardening hardening resins and a step of optically coupling a scintillator and a light guide are performed en bloc even when different types of hardening resins are used for the scintillator and the light guide.

### Means For Solving the Problem

This invention is constituted as stated below to achieve the above object. A method of manufacturing a radiation detector having a scintillator with scintillation crystal layers converting radiation into fluorescence being joined to one another, a light guide that receives fluorescence, and a light detector that detects fluorescence optically coupled to one another. The method includes the steps of manufacturing the light guide through hardening of a first hardening resin; forming a temporary assembly prior to joining of the scintillation counter crystals through arrangement of the scintillation counter crystals; arranging the temporary assembly in a recess of a receptacle for joint that is formed toward a vertical direction; pouring a second hardening resin prior to hardening into the recess to sink the temporary assembly thereinto; placing the light guide over one surface of the temporary assembly exposed from the recess, and interposing the second hardening resin in a gap between the light guide and the one surface of the temporary assembly; hardening the second hardening resin to manufacture the scintillator with the scintillation counter crystals joined to one another and to join the scintillator and the light guide; and optically coupling the light guide and the light detector.

### Operation and Effect

According to this invention, the method of manufacturing the radiation detector may be provided in which the step of hardening the second hardening resin and the step of optically coupling the scintillator and the light guide are performed en bloc. In other words, the scintillator of this invention is manufactured by forming the temporary assembly having the scintillation counter crystals arranged therein, and penetrating gaps between the scintillation counter crystals with the second hardening resin, and then hardening it. According to this invention, the scintillator is not manufactured merely by hardening the second hardening resin, but the light guide is placed so as to cover the top face of the temporary assembly that sinks into the second hardening resin prior to hardening. As a result, the second hardening resin is to be interposed in a gap between the top face of the temporary assembly and one surface of the light guide directed downward in the vertical direction. According to this invention, the second hardening resin is hardened while the light guide is placed on the temporary assembly. Consequently, the second hardening resin that penetrates the gaps between the scintillation counter crystals constituting the temporary assembly hardens to join the scintillation counter crystals to one another. Moreover, the second hardening resin interposed in the gap between the top face of the temporary assembly and the light guide and penetrating the top surface of the temporary assembly hardens, thereby joining the scintillator and the light guide. Therefore, the configuration of this invention may realize manufacturing of the radiation detector with no complicated process of forming the scintillator and the light guide individually and coupling them with the optical adhesive.

It is more desirable that the step of placing a light guide jig is further included that places the light guide jig for determining a relative position of the light guide of the foregoing configuration and the temporary assembly in the receptacle for joint.

### Operation and Effect

According to the foregoing configuration, accurate joining of the scintillator and the light guide may be ensured. Specifically, when the light guide is placed so as to cover the top face of the temporary assembly, the light guide and the temporary assembly are relatively positioned through contacting of the light guide to the light guide jig. The light guide jig is placed in the receptacle for joint with the temporary assembly arranged therein. Consequently, the light guide and the temporary assembly are relatively positioned via the receptacle for joint and the light guide jig. The relative position of the light guide and the temporary assembly is always fixed for every manufacture of the radiation detector. Accordingly, the relative position of the light guide and the scintillator is to be reproduced for every manufacture of the radiation detector.

The light guide jig of the foregoing configuration has an L-shape that extends in a first direction and a second direction seen from the vertical direction. It is more preferable that a relative position of the light guide and the temporary assembly are determined with respect to the first direction and the second direction.

### Operation and Effect

According to the foregoing configuration, accurate joining of the scintillator and the light guide may be ensured. Specifically, where the light guide jig has an L-shape, the light guide may be contacted to the light guide jig in two directions of the first direction and the second direction that is perpendicular thereto. Such configuration may realize relative positioning of the light guide with respect to the temporary assembly in two directions of the first direction and second direction perpendicular thereto. Accordingly, one relative position of the light guide with respect to the temporary assembly is to be determined naturally. As noted above, the foregoing configuration may ensure accurate joining of the scintillator and the light guide.

This invention may be configured as stated below in order to achieve the above object. A method of manufacturing a radiation detector having a scintillator with scintillation crystal layers converting radiation into fluorescence being joined to one another, a light guide that receives fluorescence, and a light detector that detects fluorescence optically coupled to one another. The method may include the steps of manufacturing the scintillator by joining the scintillation counter crystals to one another through hardening of a second hardening resin; pouring a first hardening resin prior to hardening to a vertical opening of a mold; placing the scintillator so as to cover the opening, whereby the first hardening resin penetrates one surface of the scintillator directed downward in the vertical direction; hardening the first hardening resin to manufacture the light guide and to join the scintillator and the light guide; and optically coupling the light guide and the light detector.

### Operation and Effect

With the foregoing configuration, the method of manufacturing the radiation detector may be provided in which the step of hardening the first hardening resin and the step of optically coupling the scintillator and the light guide are performed en bloc. Specifically, the light guide of the foregoing configuration is manufactured by pouring the first hardening resin into the mold and hardening it. According to the foregoing configuration, the light guide is not manufactured merely by hardening the first hardening resin, but the scintillator is placed so as to cover the opening of the mold filled with the first hardening resin prior to hardening. As a result, the first hardening resin is to penetrate one surface of the scintillator directed downward in the vertical direction. Moreover, according to the foregoing configuration, the first hardening resin hardens while the light guide is placed on the scintillator. Consequently, the first hardening resin hardens to form the light guide, and moreover, the first hardening resin that penetrates the one surface of the scintillator directed downward in the vertical direction hardens, thereby joining the scintillator and the light guide. Therefore, the foregoing configuration may realize manufacturing of the radiation detector with no complicated process of forming the scintillator and the light guide individually and coupling them with the optical adhesive.

The step may further be included of placing a scintillator jig on the mold for determining a relative position of the scintillator and the light guide.

### Operation and Effect

According to the foregoing configuration, accurate joining of the scintillator and the light guide may be ensured. Specifically, when the first hardening resin penetrates the one surface of the scintillator directed downward in the vertical direction, the scintillator and the opening of the mold are relatively positioned through contacting of the scintillator to the scintillator jig. The scintillator jig is placed in the mold having the opening for forming the light guide. Consequently, the scintillator and the light guide are relatively positioned via the mold and the scintillator jig. The relative position of the scintillator and the opening of the mold is always fixed for every manufacture of the radiation detector. Accordingly, the relative position of the scintillator and the light guide is to be reproduced for every manufacture of the radiation detector.

The scintillator jig of the foregoing configuration has an L-shape that extends in a first direction and a second direction seen from the vertical direction. It may be characterized that a relative position of the scintillator and the light guide are determined with respect to the first direction and the second direction.

### Operation and Effect

According to the foregoing configuration, accurate joining of the light guide and the scintillator may be ensured. Specifically, where the scintillator jig is L-shaped, the scintillator may be contacted to the scintillator jig in two directions of the first direction and the second direction perpendicular thereto when the first hardening resin penetrates the one surface of the scintillator directed downward in the vertical direction. Such configuration may realize relative positioning of the scintillator with respect to the opening of the mold in the first direction and second direction perpendicular thereto. Accordingly, one relative position of the scintillator with respect to the light guide is to be determined naturally. As noted above, the foregoing configuration may ensure accurate joining of the scintillator and the light guide.

The scintillator of the foregoing configuration may have the scintillation counter crystals arranged in a three-dimensional array.

### Operation and Effect

According to the foregoing configuration, a radiation detector may be provided that allows three-dimensional discrimination of fluorescence generation positions in the scintillator. Such configuration may ensure more accurate mapping of radiation generation positions when the radiation detectors according to this invention are arranged in the radiation tomography apparatus.

The first hardening resin and the second hardening resin in the foregoing configuration may be selected from materials different from each other.

### Operation and Effect

According to the foregoing configuration, a radiation detector may be provided that allows varying in setting in accordance with various applications. Suitable materials for the first hardening resin for forming the light guide and the second hardening resin for forming the scintillator through joining of the scintillation counter crystals may vary depending on a size of the radiation detector, a property of radiation to be detected, or a material of the scintillation counter crystal, etc. The foregoing configuration may realize selection of the first hardening resin and the second hardening resin from the materials different from each other, which results in provision of various types of radiation detectors.

### Effect of the Invention

According to this invention, the method of manufacturing the radiation detector may be provided in which the step of hardening the hardening resin and the step of optically coupling the scintillator and the light guide are performed en bloc. Here, both steps of manufacturing the scintillator and the light guide include the step of hardening the hardening resin. Giving attention to this, this invention has no configuration of optically coupling the light guide and the scintillator after manufacturing independently the light guide or the scintillator. Instead of this configuration, this invention has a configuration of manufacturing either the light guide or the scintillator and then placing either the manufactured light guide or the scintillator on the incomplete scintillator or light guide. Such configuration allows one surface of the light guide or the scintillator to be penetrated with the hardening resin prior to hardening. When the hardening resin hardens under this state, the hardening resin that penetrates the one surface of the light guide or the scintillator is to harden, which results in joining of the light guide and the scintillator.

As noted above, the method of manufacturing the radiation detector may be provided in which the step of hardening the hardening resin to manufacture the scintillator or the light guide and the step of optically coupling the scintillator and the light guide are performed en bloc. Accordingly, the radiation detector may be manufactured with no complicated process of forming the scintillator and the light guide individually and coupling them with the optical adhesive.

### BRIEF DESCRIPTION OF THE DRAWINGS

FIG. 1 is a perspective view of a radiation detector according to Embodiment 1.

FIG. 2 is a plan view showing a configuration of a light guide according to Embodiment 1.

FIG. 3 is a plan view showing processes of discriminating fluorescence generating positions of the radiation detector according to Embodiment 1.

FIG. 4 is a perspective view showing a configuration of an optical member frame according to Embodiment 1.

FIG. 5 is a flow chart showing a method of manufacturing the radiation detector according to Embodiment 1.

FIG. 6 is a perspective view showing a step of manufacturing the optical member frame according to Embodiment 1.

FIG. 7 is a perspective view showing a configuration of a mold according to Embodiment 1.

FIG. 8 is a sectional view showing a step of inserting the optical member frame and a step of pouring a first hardening resin according to Embodiment 1.

FIG. 9 is a perspective view showing a configuration of a receptacle for arrangement according to Embodiment 1.

FIGS. 10 to 16 are sectional views each showing a method of manufacturing a scintillator according to Embodiment 1.

FIG. 17 is a sectional view showing a step of pouring a second hardening resin and a step of placing a temporary assembly according to Embodiment 1.

FIG. 18 is a sectional view showing the step of placing the temporary assembly according to Embodiment 1.

FIG. 19 is a perspective view showing a step of placing a light guide jig and a step of placing a light guide according to Embodiment 1.

FIG. 20 is a plan view showing the step of placing the light guide according to Embodiment 1.

FIG. 21 is a sectional view showing the step of placing the light guide according to Embodiment 1.

FIG. 22 is a flow chart showing a method of manufacturing a radiation detector according to Embodiment 2.

FIG. 23 is a perspective view showing the method of manufacturing the radiation detector according to Embodiment 2.

FIG. 24 is a plan view showing a step of placing a light guide according to Embodiment 2.

FIG. 25 is a sectional view showing the step of placing the light guide according to Embodiment 2.

FIG. 26 is a perspective view showing a configuration of a conventional radiation detector.

### DESCRIPTION OF REFERENCES

1 radiation detector

2 scintillator

2p temporary assembly

3 light detector

4 light guide

8 thermosetting resin (first hardening resin)

11 scintillation counter crystal

20 receptacle for joint

20a recess

21 optical adhesive (second hardening resin)

22 scintillator jig

24 light guide jig

### BEST MODE FOR CARRYING OUT THE INVENTION

Description will be give hereinafter of a method of manufacturing a radiation detector according to this invention with reference to the drawings.

### Embodiment 1

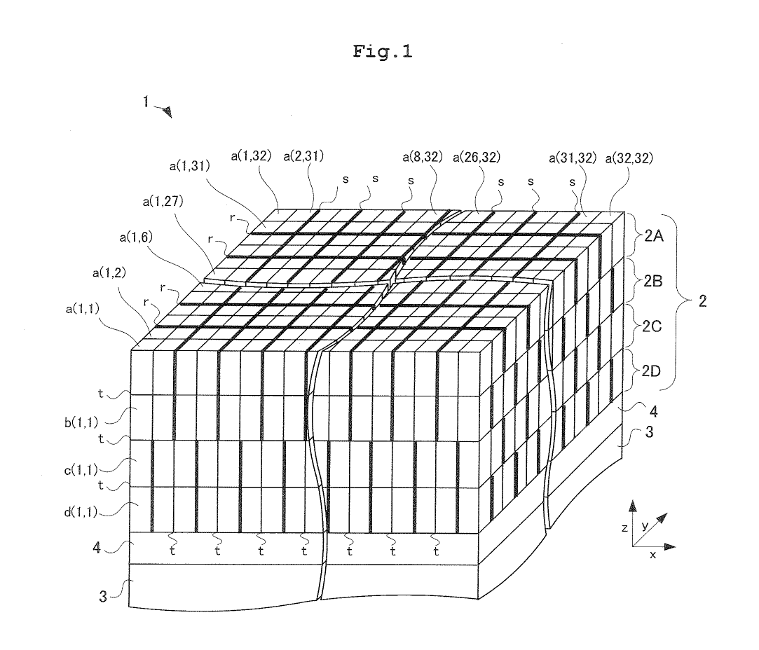

Prior to description of a method of manufacturing a radiation detector according to Embodiment 1, a configuration is to be described of a radiation detector 1 according to Embodiment 1. FIG. 1 is a perspective view of the radiation detector according to Embodiment 1. As shown in FIG. 1, the radiation detector 1 according to Embodiment 1 includes a scintillator 2 that is formed of scintillation counter crystal layers each laminated in order of a scintillation counter crystal layer 2D, a scintillation counter crystal layer 2C, a scintillation counter crystal layer 2B, and a scintillation counter crystal layer 2A, in turn, in a z-direction, a photomultiplier tube (hereinafter referred to as a light detector) 3 having a function of position discrimination that is provided on an undersurface of the scintillator 2 for detecting fluorescence emitted from the scintillator 2 for receiving fluorescence, and a light guide 4 arranged between the scintillator 2 and the light detector 3. Consequently, each of the scintillation counter crystal layers is laminated in a direction toward the light detector 3. In other words, the scintillator 2 has scintillation counter crystals arranged in a three-dimensional array. Here, the z-direction corresponds to the vertical direction in this invention.

Here, the scintillation counter crystal layer 2A corresponds to an incident surface of radiation in the scintillator 2. Each of the scintillation counter crystal layers 2A, 2B, 2C, and 2D is optically coupled, and includes a transparent material t of a hardened thermosetting resin between each of the layers. A thermosetting resin composed of a silicone resin may be used for the transparent material t. The scintillation counter crystal layer 2A corresponds to a receiver of the gamma rays emitted from a radioactive source. The scintillation counter crystals in a block shape are arranged in a two-dimensional array with thirty-two numbers of the scintillation counter crystals in an x-direction and thirty-two numbers of the scintillation counter crystals in a y-direction relative to a scintillation counter crystal a (1, 1). That is, the scintillation counter crystals from a (1, 1) to a (1, 32) are arranged in the y-direction to form a scintillator crystal array. Thirty-two numbers of the scintillator crystal arrays are arranged in the x-direction to form a scintillation counter crystal layer 2A. Here, as for the scintillation counter crystal layers 2B, 2C, and 2D, thirty-two numbers of the scintillator counter crystals are also arranged in the x-direction and the y-direction in a matrix in a two-dimensional array relative to a scintillation counter crystal b (1, 1), c (1, 1), and d (1, 1), respectively. In each of the scintillation counter crystal layers 2A, 2B, 2C, and 2D, the transparent material t is also provided between the scintillation counter crystals adjacent to each other. Consequently, each of the scintillation counter crystals is to be enclosed with the transparent material t. The transparent material t has a thickness around 25 μm. The x-direction and the y-direction correspond to the first direction and the second direction, respectively, in this invention. A gamma ray corresponds to radiation in this invention.

First reflectors r that extend in the x-direction and second reflectors s that extend in the y-direction are provided in the scintillation counter crystal layers 2A, 2B, 2C, and 2D provided in the scintillator 2. Both reflectors r and s are inserted in a gap between the arranged scintillation counter crystals.

The scintillator 2 has scintillation counter crystals suitable for detection of gamma rays in a three-dimensional array. That is, the scintillation counter crystal is composed of Ce-doped Lu_{2(1-X)}Y₂XSiO₅ (hereinafter referred to as LYSO.) Each of the scintillation counter crystals is, for example, a rectangular solid having a length of 1.45 mm in the x-direction, a width of 1.45 mm in the y-direction, and a height of 4.5 mm regardless of the scintillation counter crystal layer. The scintillator 2 has four side end faces that are covered with a reflective film not shown. The light detector 3 is multi-anode type, and allows position discrimination of incident fluorescence in the x and y.

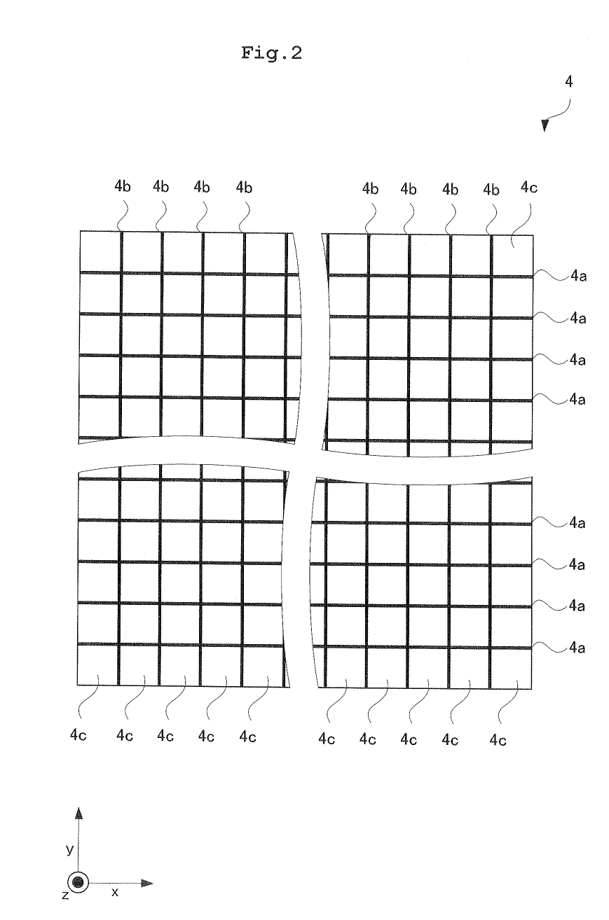

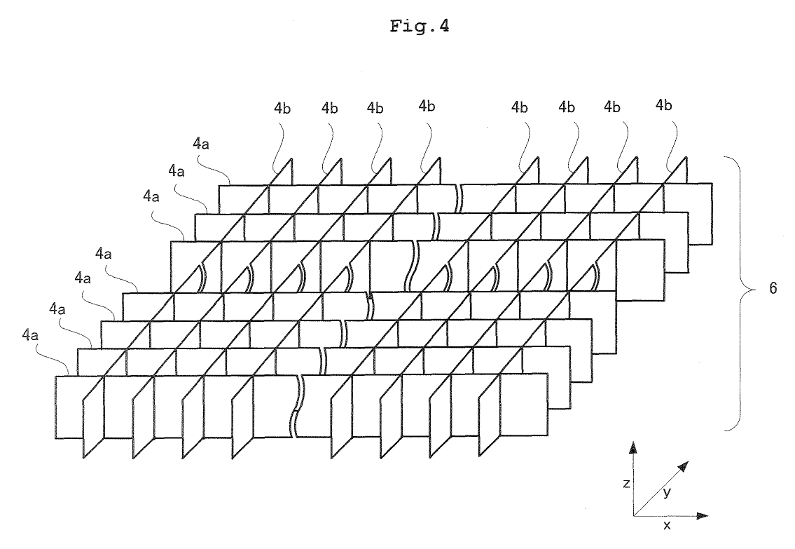

The light guide 4 is provided for guiding fluorescence emitted in the scintillation 2 into the light detector 3. Consequently, the light guide 4 is optically coupled to the scintillator 2 and the light detector 3. The configuration of the light guide 4 will be described. FIG. 2 is a plan view showing a configuration of the light guide according to Embodiment 1. As shown in FIG. 2, the light guide 4 has thirty-one elongated first optical members 4a extending in the x-direction that are arranged in the y-direction so as to pass through the light guide 4 in the z-direction. Moreover, the light guide 4 has thirty-one elongated second optical members 4b extending in the y-direction that are arranged in the x-direction so as to pass through the light guide 4 in the z-direction. The first optical members 4a and the second optical members 4b form a lattice optical member frame 6 as shown in FIG. 4, when seen as a whole the light guide 4. A resin block 4c that transmits light is inserted into each section that the optical member frame 6 divides (see FIG. 2.) The resin block 4c is also provided on the side end of the light guide 4. Consequently, each of the first optical members 4a and the second optical members 4b is interposed between the resin blocks 4c. Here, the resin block 4c has a same arrangement pitch as the scintillation counter crystal layers 2A, 2B, 2C, and 2D. As a result, each of the resin blocks 4c and scintillation counter crystals d that form the scintillation counter crystal layer 2D is combined by one to one. The configuration of the optical member frame 6 will be described in detail hereinafter. Both of the first optical member and the second optical member is preferably an ESR film (Sumitomo 3M) as a reflector having a thickness of around 65 μm.

The first optical member 4a and the second optical member 4b are composed of a reflector that reflects fluorescence emitted in the scintillator 2. Consequently, the optical member frame 6 (see FIG. 4) does not permit fluorescence that enters from the scintillator 2 into the light guide 4 to spread in the xy-directions. Fluorescence enters into the light detector 3. Accordingly, the light guide 4 allows fluorescence to receive from the scintillator 2 to the light detector 3 while maintaining a position where fluorescence is generated in the xy-directions.

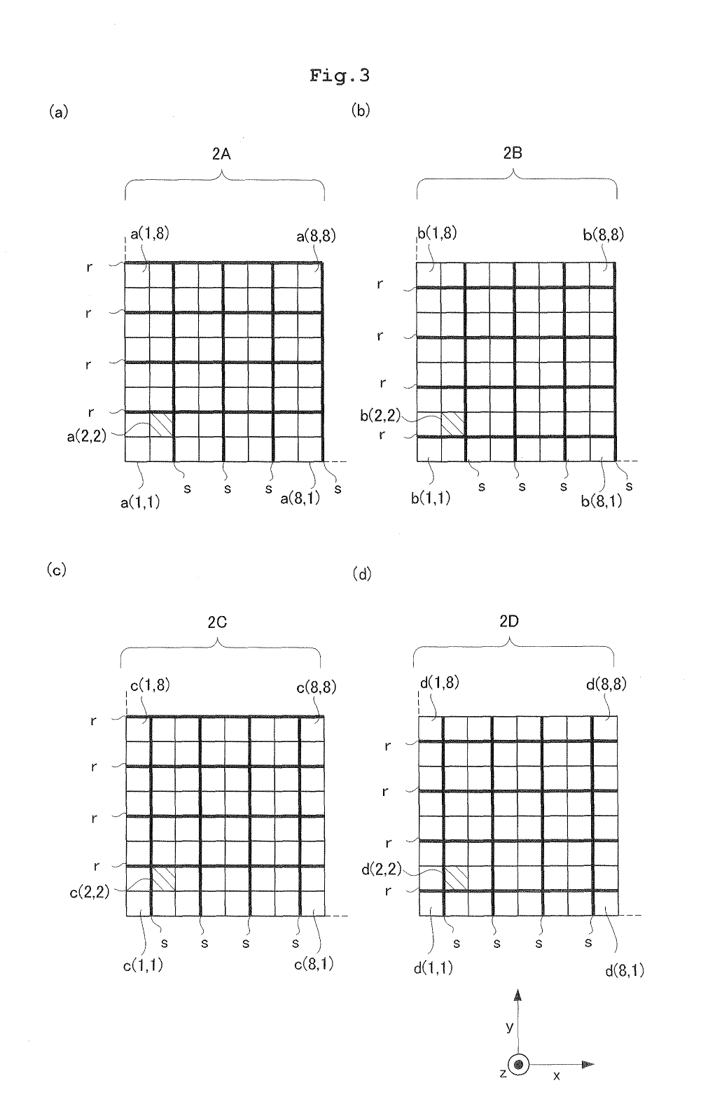

Description will be given of a process of discriminating a fluorescence generating position in the z-direction in the radiation detector 1 according to Embodiment 1. As shown in FIG. 3, each of the scintillation counter crystal layers 2A, 2B, 2C, and 2D that form the scintillator 2 differs from one another in inserting positions of the first reflectors r and the second reflectors s. FIG. 3 shows one end of the scintillator 2 according to Embodiment 1, and (a), (b), (c) and (d) therein illustrate configurations of the scintillation counter crystal layers 2A, 2B, 2C, and 2D, respectively. Directing attention to the scintillation counter crystals a (2, 2), b (2, 2), c (2, 2), and d (2, 2) on (2, 2), all of the four have two sides adjacent to each other that are covered with the reflectors. The scintillation counter crystals on (2, 2) differ from one another in direction where the reflectors are provided. Thus, four scintillation counter crystals (2, 2), b (2, 2), c (2, 2), and d (2, 2) that are identical to one another in the xy-positions have different optical conditions. The fluorescence generated in the scintillation counter crystal reaches the light detector 3 while spreading in the xy-directions. Providing the reflectors leads to addition of directivity to the spreading. Moreover, comparing fluorescence generated in the four scintillation counter crystals having the same xy-positions, they differ from one another in direction of spreading. That is, differences in position of generating fluorescence in the z-direction in the scintillator 2 are to be converted into differences of fluorescence in the xy-directions. The light detector 3 may detect a slight deviation of the fluorescence in the xy-directions due to the differences in the position in the z-direction, and may calculate the position of generating fluorescence in the z-direction from it.

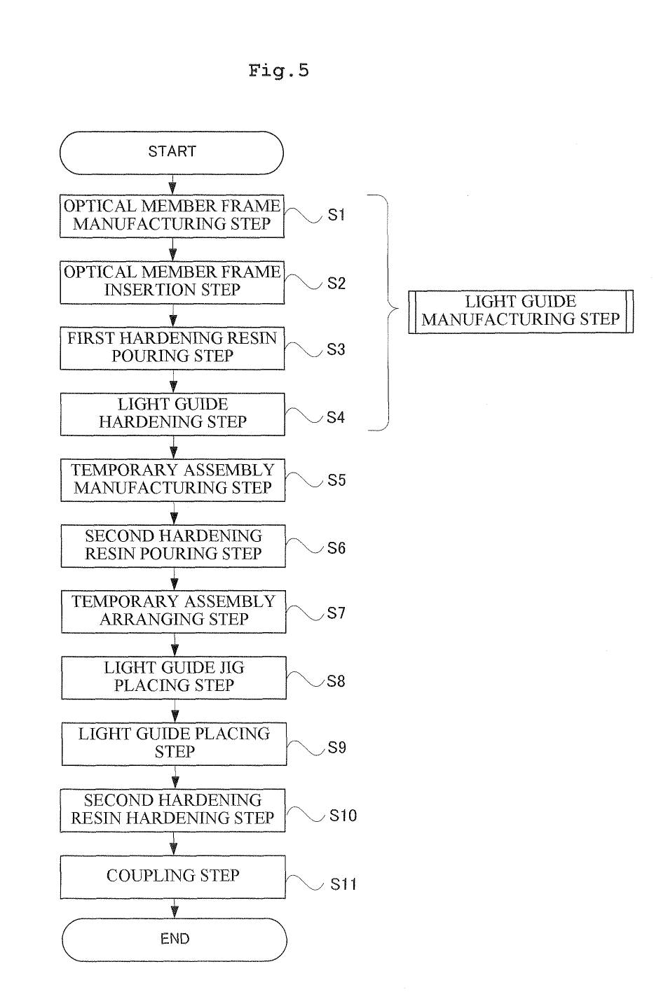

Description will be given of a method of manufacturing such a radiation detector noted above. FIG. 5 is a flow chart showing a method of manufacturing the radiation detector according to Embodiment 1. As shown in FIG. 5, the method of manufacturing the radiation detector according to Embodiment 1 includes the step S1 of manufacturing an optical member frame that constitutes a light guide, the step S2 of inserting an optical member frame that inserting the optical member frame 6 into an opening 7a of the mold 7, the step S3 of pouring a first hardening resin that pours the first hardening resin into the opening 7a, and the step S4 of hardening the light guide that hardens and completes the light guide 4. The foregoing steps correspond to the step of manufacturing the light guide according to Embodiment 1.

The method of manufacturing the radiation detector according to Embodiment 1 includes, subsequent to the step of manufacturing the light guide, the step S5 of manufacturing a temporary assembly that manufactures the temporary assembly 2p having the scintillation counter crystals 11 arranged three-dimensionally; the step S6 of pouring a second hardening resin that pours the second hardening resin into the recess 20a in the receptacle for joint 20; the step S7 of arranging the temporary assembly that arranges the temporary assembly in the recess 20a; the step S8 of placing a light guide jig 24 that places the light guide jig 24 in the receptacle for joint 20; the step S9 of placing a light guide 4 that places the light guide 4 in the receptacle for joint 20; the step S10 of hardening the second hardening resin that hardens the second hardening resin; and the step S11 of optically coupling the light guide 4 and the light detector 3. Each of the foregoing will be described hereinafter.

<Optical Member Frame Manufacturing Step S1>

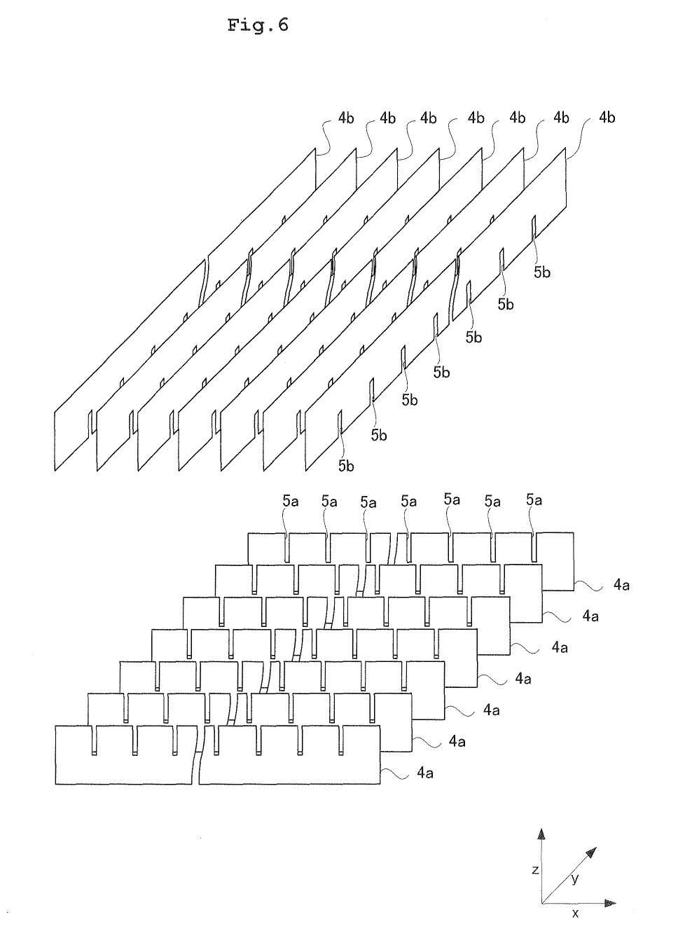

FIG. 6 is a perspective view showing a process of manufacturing the optical member frame according to Embodiment 1. The first optical members 4a are arranged in the y-direction for manufacturing the optical member frame 6 according to Embodiment 1. As shown in FIG. 6, the first optical member 4a is a strip member having a long side direction along the x-direction, a short side direction along the z-direction, and a thickness direction along the y-direction. The first optical member 4a has grooves 5a along the z-direction. Directing attention to the single optical member 4a, the grooves 5a are arranged approximately at equal intervals, and have openings provided in a uniform direction with respect to the z-direction. Moreover, as shown in FIG. 6, the second optical member 4b is a strip member having a long side direction along the y-direction, a short side direction along the z-direction, and a thickness direction along the x-direction. The second optical member 4b has grooves 5b along the z-direction.

Directing attention to the single second optical member 4b, the grooves 5b are arranged approximately at equal intervals, and have openings provided in a uniform direction with respect to the z-direction. In the optical member frame manufacturing step S1, the second optical members 4b approach the first optical members 4a along the z-direction, thereby fitting the grooves 5a and 5b of both optical members 4a and 4b to one another. Thus, the second optical members 4b are arranged in the x-direction. The first optical members 4a and the second optical members 4b are integrated with each other to manufacture the optical member frame 6 having both optical members 4a, 4b arranged in a lattice shape as shown in FIG. 4.

<Optical Member Frame Insertion Step S2>

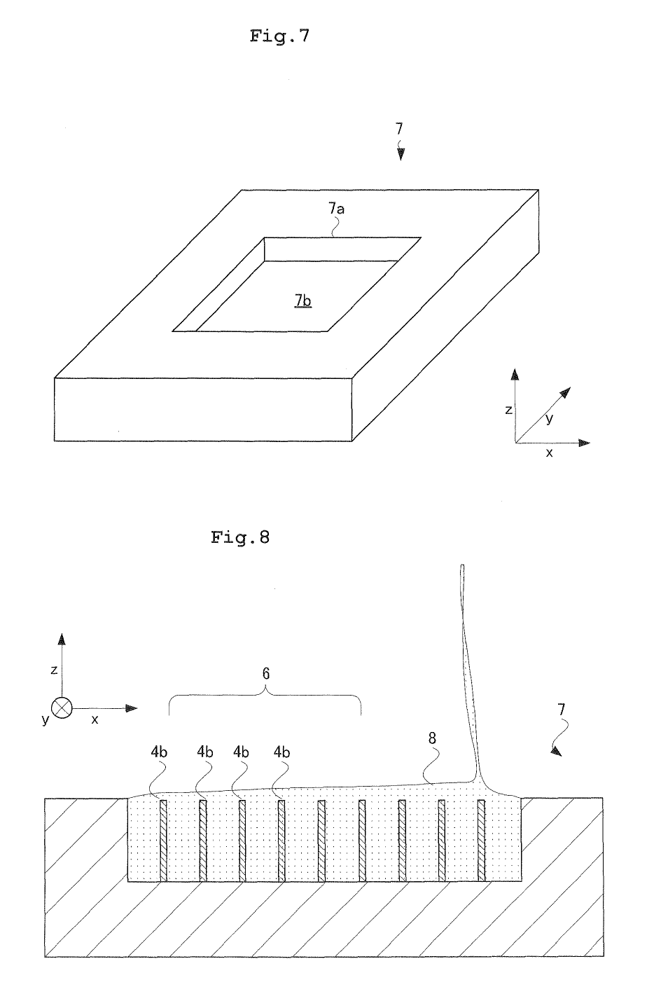

Next, the optical member frame 6 is inserted into the mold 7. Prior to explanation on the optical member insertion step S2, description will be given of the configuration of the mold 7. FIG. 7 is a perspective view showing a configuration of the mold according to Embodiment 1. The mold 7 of Embodiment 1 has an opening 7a upward in the z-direction. The opening 7a is rectangular seen in the z-direction, and has a depth in the z-direction approximately equal to a thickness of the light guide according to Embodiment 1 in the z-direction. The bottom of the opening 7a in the z- direction constitutes a close end face 7b in a planar shape. The close end face 7b may have a pressing plug, etc., formed thereon for removing the hardened light guide 4 from the mold 7. The mold 7 may be formed of a fluorocarbon resin, for example.

FIG. 8 is a sectional view showing the step of inserting the optical member frame and the step of pouring the first hardening resin according to Embodiment 1. As shown in FIG. 8, in step S2 of inserting the optical member frame, the optical member frame 6 is inserted into the opening 7a in the z-direction. Here, the opening 7a has a length in the x-direction approximately equal to that of the first optical member 4a in the long side direction, and a length of the opening 7a in the y-direction approximately equal to that of the second optical member 4b in the long side direction. As a result, four side ends of the optical member frame 6 contacts the four side end faces of the opening 7a. As shown in FIG. 7, the optical member frame 6 is inserted into the opening 7a of the mold 7. A release agent is applied in advance to the opening 7a of the mold 7 for releasing the hardened thermosetting resin 8. In FIG. 8, the number of the optical members that form the optical member frame 6 is omitted. Likewise, the number of the optical members is to be omitted in the subsequent drawings. FIG. 8 is a sectional view in the zx-plane. Embodiment 1 has a similar yz-plane in its sectional view. The z-direction here corresponds to the vertical direction in this invention.

<First Hardening Resin Pouring Step S3>

Subsequently, the first liquid thermosetting resin is poured into the opening 7a. As shown in FIG. 8, the liquid thermosetting resin 8 is poured into the opening 7a of the mold 7 in the z-direction. The thermosetting resin 8 prior to hardening is liquid. Thus, the opening 7a may readily be filled with the thermosetting resin 8. Moreover, degassing process is performed in advance to the thermosetting resin 8. When hardens, the thermosetting resin 8 is changed into a transparent solid resin so as to transmit fluorescence. In the first hardening resin pouring step S3, the optical member frame 6 inserted into the opening 7a goes down into the thermosetting resin 8. Accordingly, an upper end of the optical member frame 6 in the z-direction is covered with the thermosetting resin 8. The thermosetting resin 8 is raised from the opening 7a due to a surface tension when seen as a whole the mold 7. Here, the thermosetting resin corresponds to the first hardening resin in this invention. Specifically, an epoxy resin or acrylic resin may be used, for example.

<Light Guide Hardening Step S4>

Next, the mold 7 is put into an oven maintained at a predetermined temperature for hardening the thermosetting resin 8. Thereafter, the light guide 4 is drawn out and removed from the mold 7. The light guide 4 has a hardened meniscus on the surface that receives the light. Accordingly, the surface of the light guide 4 that receives fluorescence is ground and polished to form the light guide 4 capable of installation on the radiation detector 1. As noted above, the step of manufacturing the light guide in this invention includes the steps of manufacturing the optical member frame, inserting the optical member frame, pouring the first hardening resin, and hardening the light guide.

Next, the scintillator 2 according to Embodiment 1 is to be manufactured. Prior to manufacture of the scintillator 2, a scintillator frame 9 is formed having the first reflectors r extending in the x-direction and arranged in the y-direction and the second reflectors s extending in the y-direction and arranged in the x-direction that are coupled in a lattice shape. Since this manner is the same as that of the foregoing optical member frame 6 for the light guide 4, explanation thereon is to be omitted.

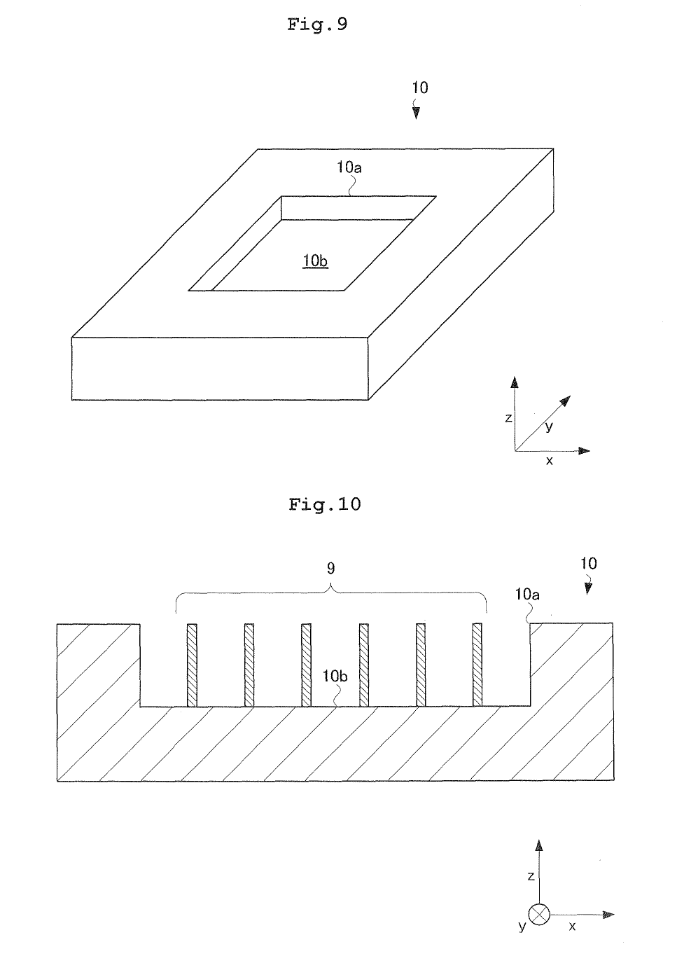

Next, the scintillator frame 9 is inserted into the receptacle for arrangement 10. Prior to explanation on this step, description will be given to the configuration of the receptacle for arrangement 10. FIG. 9 is a perspective view showing a configuration of the receptacle for arrangement 10 according to Embodiment 1. The receptacle for arrangement 10 of Embodiment 1 has an opening 7a upward in the z-direction. The opening 10a is rectangular seen in the z-direction, and has a depth in the z-direction approximately equal to a thickness of the scintillation crystal layer according to Embodiment 1 in the z-direction. Here, the opening 10a has a close end face 10b in a planar shape as a bottom thereof in the z-direction. The receptacle for arrangement 10 may be composed of, for example, a fluorocarbon resin.

FIG. 10 is a sectional view showing a process of manufacturing the scintillator according to Embodiment 1. As shown in FIG. 10, the scintillator frame 9 is inserted into the opening 10a in the z-direction. Here, the opening 10a has a length in the x-direction approximately equal to that of the first reflector r in the long side direction, and a length in the y-direction approximately equal to that of the second reflector s in the long side direction. As a result, four side ends of the scintillator frame 9 contact the four side end faces of the opening 10a. As shown in FIG. 10, the scintillator frame 9 is inserted into the opening 10a of the receptacle for arrangement 10. Here in FIG. 10, the number of the reflectors that constitute the scintillator frame 9 is omitted. Likewise, the number of the reflectors is to be omitted in the subsequent drawings. FIGS. 10 to 12 are sectional views in the zx-plane. Embodiment 1 has a similar yz-plane in its sectional view.

<Temporary Assembly Manufacturing Step S5>

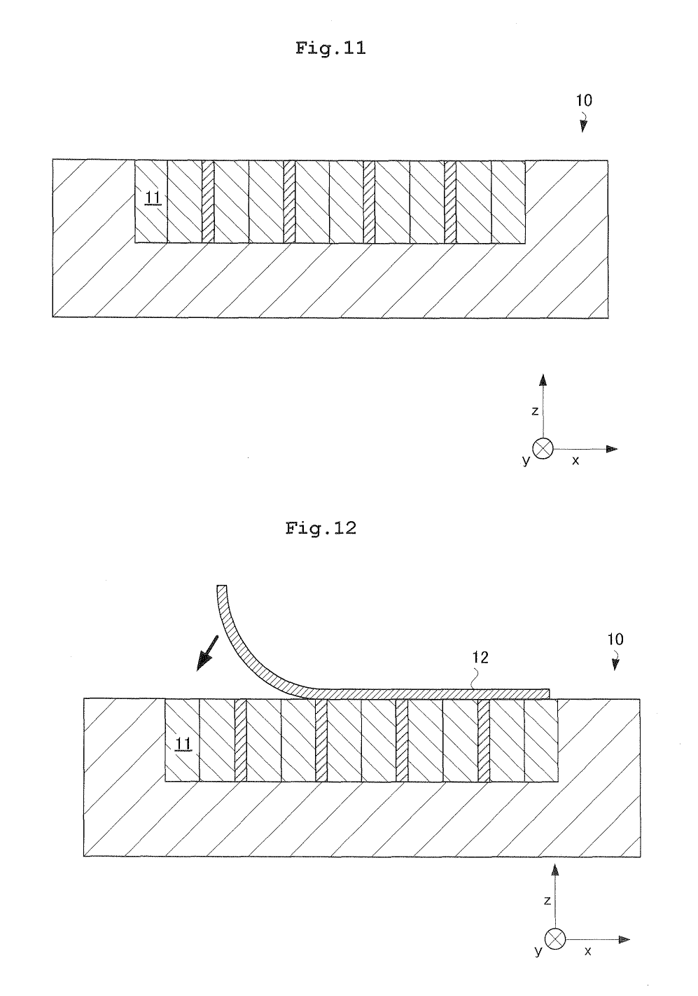

Thereafter, the scintillation counter crystals 11 are inserted into the opening 10a, whereby the scintillation counter crystal layer 2A is formed. The opening 10a has a depth in the z-direction approximately equal to a height of the scintillation counter crystals 11 in the z-direction. Here, clearance of the adjacent first reflectors r in the scintillator frame 9 is twice a length of the scintillation counter crystals 11 to be inserted in the y-direction. Clearance of the adjacent second reflectors s in the scintillator frame 9 is twice a length of the scintillation counter crystals 11 to be inserted in the x-direction. In this step, the scintillation counter crystals 11 are inserted into each section divided by the scintillator frame 9. Accordingly, two scintillation counter crystals 11 are inserted between the first reflectors r adjacent to each other, and two scintillation counter crystals 11 are inserted between the second reflectors s adjacent to each other. Consequently, as shown in FIG. 11, the opening 10a is filled with the scintillation counter crystals 11. Seen as a whole of the opening 10a, thirty-two scintillation counter crystals 11 are arranged two-dimensionally in the xy-directions.

Next, as shown in FIG. 12, an adhesive tape 12 is joined to an exposed surface of the scintillation counter crystal layer 2A that is exposed from the opening 10a to temporarily join each of the scintillation counter crystals 11. Thereafter, the scintillation counter crystal layer 2A is drawn out in the z-direction with the tape joined thereto to remove the scintillation counter crystal layer 2A from the opening 10a of the receptacle for arrangement 10.

Four scintillation counter crystal layers are to be manufactured by repeating each of such steps illustrated in FIGS. 10 to 12. Each of the scintillation counter crystals is drawn out from the receptacle for arrangement 10, and then stacked in the z-direction, whereby the temporary assembly 2p is formed having the scintillation counter crystals arranged three-dimensionally. Explanation is to be given on this manner. Prior to explanation on each of the steps concerning such operations, a configuration of a receptacle for stack 15 according to Embodiment 1 is to be described. FIG. 13 is a sectional view showing a configuration of the receptacle for stack according to Embodiment 1. As shown in FIG. 13, the receptacle for stack 15 that is used for stacking the scintillation counter layers has a receptacle body 16, a top board 17, and a screw shaft 18. The receptacle body 16 has a recess 16a that is open upward in the z-direction and a screw hole 16b formed on the bottom face thereof. The plate top board 17 is provided inside the recess 16a so as to close thereof. The top board 17 is supported by one end of the screw shaft 18 that extends in the z-direction. Moreover, a handle not shown is attached on the other end of the screw shaft 18 that turns the screw shaft 18. The level of the screw shaft 18 that projects in the z-direction is adjusted through operation of the handle. Accordingly, the top board 17 may move vertically in the z-direction. Here, the screw shaft 18 supports the top board 17 so as to rotate freely. The four side surfaces of the recess 16a guide the top board 17, whereby the top board 17 moves vertically in the z-direction without rotating along with the screw shaft 18. FIGS. 13 to 18 are sectional views in the zx-plane. Embodiment 1 has a similar yz-plane in its sectional view.

Prior to insertion of the scintillation counter layers into the recess 16a of the receptacle for stack 15, a pair of strip films 19 is placed along the recess 16a. In FIG. 13, the film 19 is placed along the recess 16a so as to cover two side surfaces among the four side surfaces of the recess 16a that face to the yz-plane and are directed to each other and the top board 17 collectively. Here, merely one film 19 is illustrated in the drawings. Likewise, the other film 19 is placed along the recess 16a so as to cover two side surfaces that face to the zx-plane and are directed to each other and the top board 17 collectively. The top board 17 is controlled as to have a distance Dz from the top face thereof to the front end of the receptacle for stack 15. Here, Dz is no more than the level of the scintillation counter crystal layer in the z-direction.

Next, the scintillation counter layer 2A is inserted into the recess 16a of the receptacle for stack 15. A pair of films 19 is already placed on the recess 16a, and thus five surfaces among six surfaces of the scintillation counter crystal layer 2A are adjacent to the films 19. The rest one surface is an exposed surface that is exposed from the opening of the recess 16a. A direction where the scintillation counter crystal layer 2A is inserted into the recess 16a is selected such that the surface with the tape 12 joined thereto is the exposed surface.

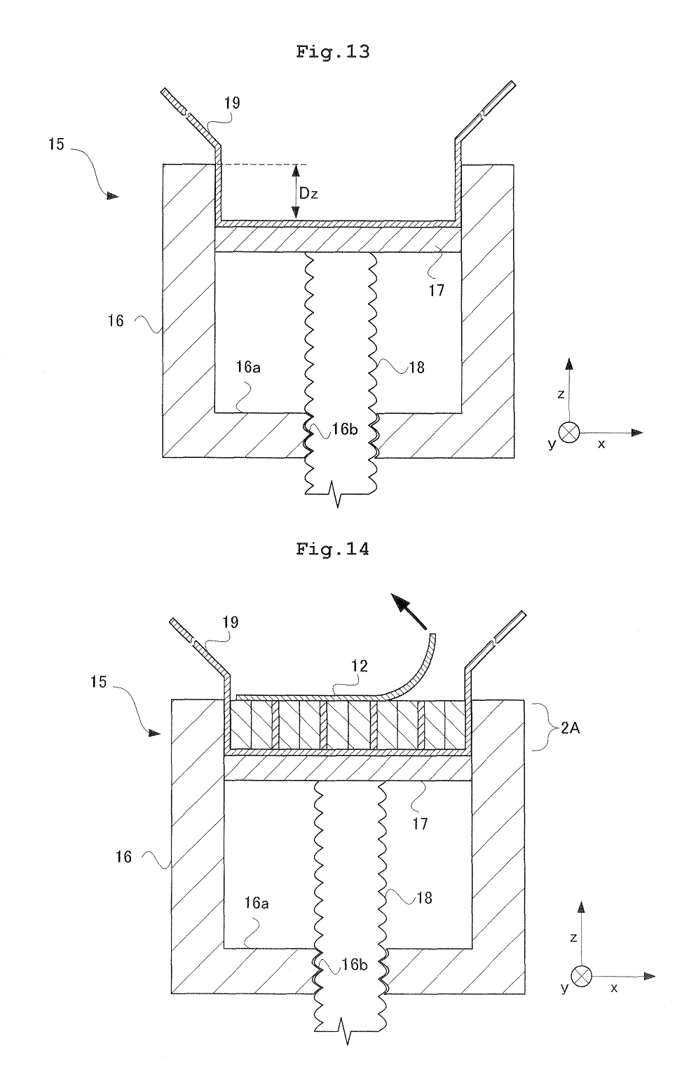

FIG. 14 is a sectional view showing a method of manufacturing the temporary assembly according to Embodiment 1. In this step, the tape 12 joined to the scintillation counter layer 2A is separated from the scintillation counter layer 2A. Description will be given of a position of the tape 12 in the z-direction. Here, Dz is no more than the level of the scintillation counter crystal layer in the z-direction. Consequently, all spaces formed with the top board 17 and the recess 16a are filled again with the scintillation counter crystal layer 2A. Consequently, the tape 12 fails to enter into the recess 16a. The tape 12 may be readily separated with no interference of the receptacle body 16.

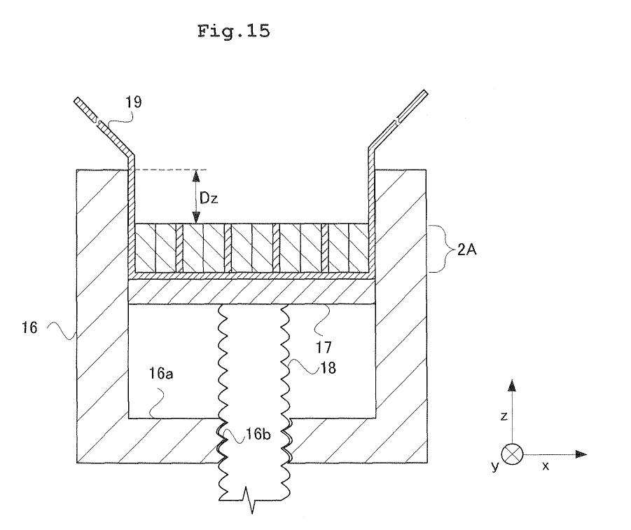

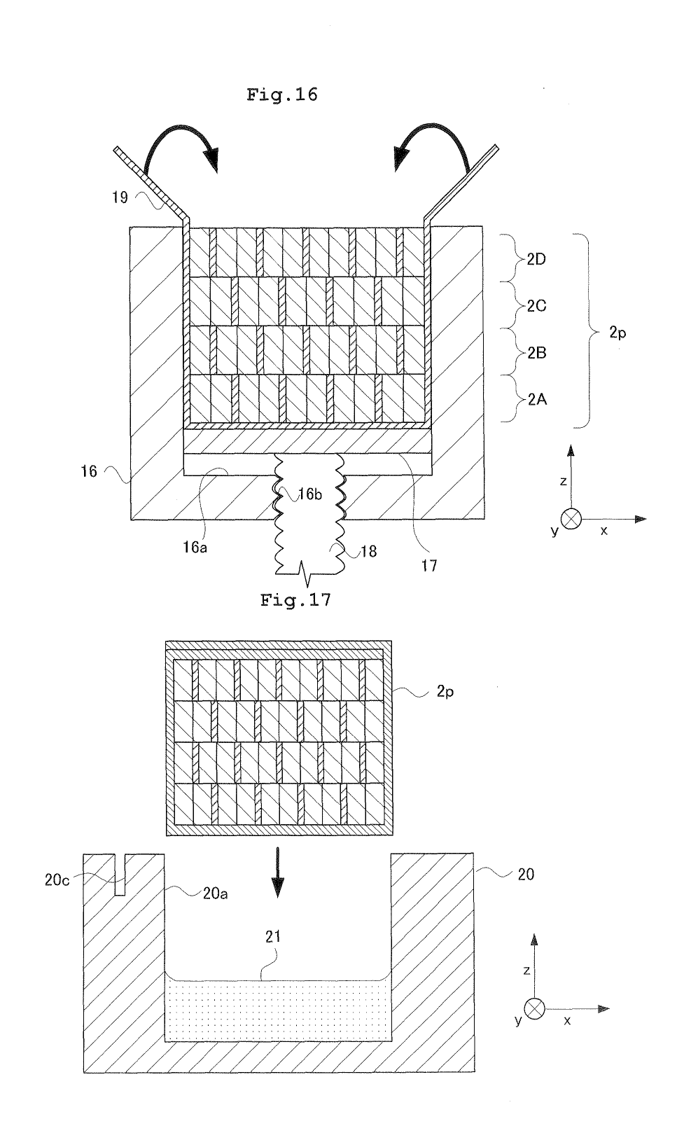

Thereafter, as shown in FIG. 15, the handle attached on the screw shaft 18 operates to move the top board 17 downward and controls as to have a distance Dz from the top surface of the scintillation crystal layer 2A to the front end of the receptacle for stack 15. Then, the scintillation counter crystal layer 2B is inserted so as to cover the scintillation counter crystal layer 2A. Such operation is repeated, and consequently the temporary assembly 2p having the scintillation counter crystals arranged three-dimensionally is formed inside the recess 16a (see FIG. 16.)

Subsequently, the temporary assembly 2p is surrounded with the films 19 by folding opposite ends of the films 19 toward the inside of the recess 16a, which is illustrated in FIG. 16. As a result, all six surfaces of the temporary assembly 2p are covered with the films 19 and two or more scintillation counter crystal layers are surrounded with a pair of films 19 collectively. Moreover, tongues of the films 19 are joined to each other, whereby the scintillation counter crystals 11 are bound firmly with the films 19.

<Second Hardening Resin Pouring Step S6 and Temporary Assembly Arranging Step S7>

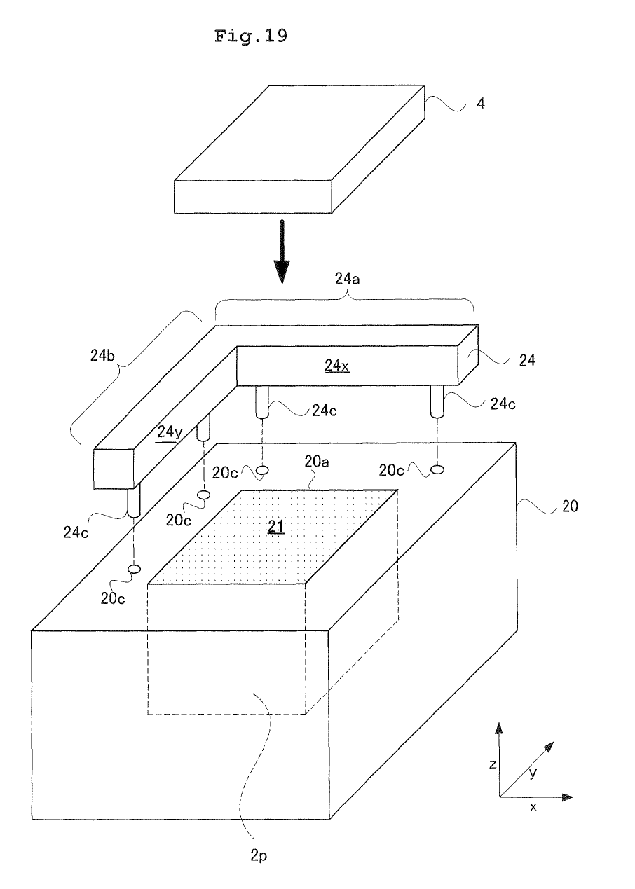

Next, as shown in FIG. 17, the optical adhesive 21 prior to hardening is poured in advance into the recess 20a of the receptacle for joint 20 that is formed toward the z. The receptacle for joint 20 has the recess 20a of a level approximately equal to that of the scintillator 2 in the z-direction. The recess 20a has a U-shaped section along the zx-plane and the xz-plane. The recess 20a has a depth approximately equal to the level of the temporary assembly 2p in the z-direction. Moreover, the receptacle for joint 20 has two or more slits 20c provided in the front surface thereof. The slits 20c are arranged in the L-shape along two sides of the recess 20a that is rectangular seen in the vertical direction (see FIG. 19.) A release agent is applied to the recess 20a prior to pouring of the optical adhesive 21. Here, the optical adhesive 21 is, for example, a silicon or epoxy adhesive, and corresponds to the second hardening resin in this invention.

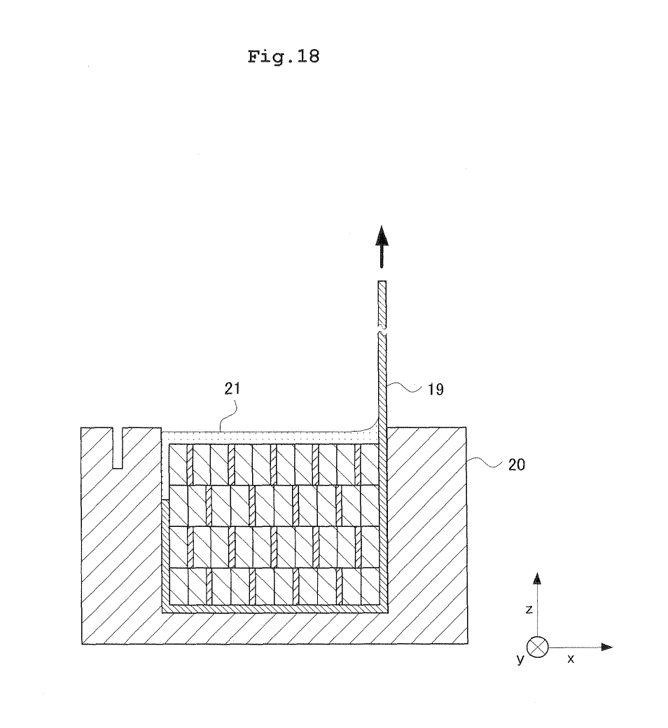

Next, the temporary assembly 2p surrounded with the films 19 is drawn out from the receptacle for stack 15. Specifically, the handle is operated to lift for removal of the temporary assembly 2p ejected from the front of the receptacle for stack 15. The scintillation counter crystals 11 are bound firmly with a pair of the films 19 collectively. Accordingly, the scintillation counter crystals 11 are not separated at this time. Thereafter, the temporary assembly 2p is inserted into the recess 20a of the receptacle for joint 20 together with the films 19, and sinks into the optical adhesive 21. Here, the recess 20a is set under a reduced pressure environment, whereby the optical adhesive 21 is completely spread over the gaps between the scintillation counter crystals 11. Then, joining of each tongue in the films 19 is released and folding thereof is also released. The films 19 are drawn out from the recess 20a in the z-direction, which is illustrated in FIG. 18.

<Light Guide Jig Placing Step S8>

Subsequently, as shown in FIG. 19, the light guide jig 24 is placed on the upper end of the receptacle for joint 20. The light guide jig 24 is a jig having a first portion 24a extending in the x-direction and a second portion 24b extending in the y-direction that are coupled in the L-shape. Consequently, the light guide jig 24 is L-shaped seen in the z-direction (the vertical direction.) The first portion 24a and the second portion 24b of the light guide jig 24 have nibs 24c that extend downward in the vertical direction. Upon placing of the light guide jig 24 in the receptacle for joint 20, the nibs 24c are fitted into the slits 20c on the upper end of the receptacle for joint 20 that are arranged in the L-shape.

<Light Guide Placing Step S9>

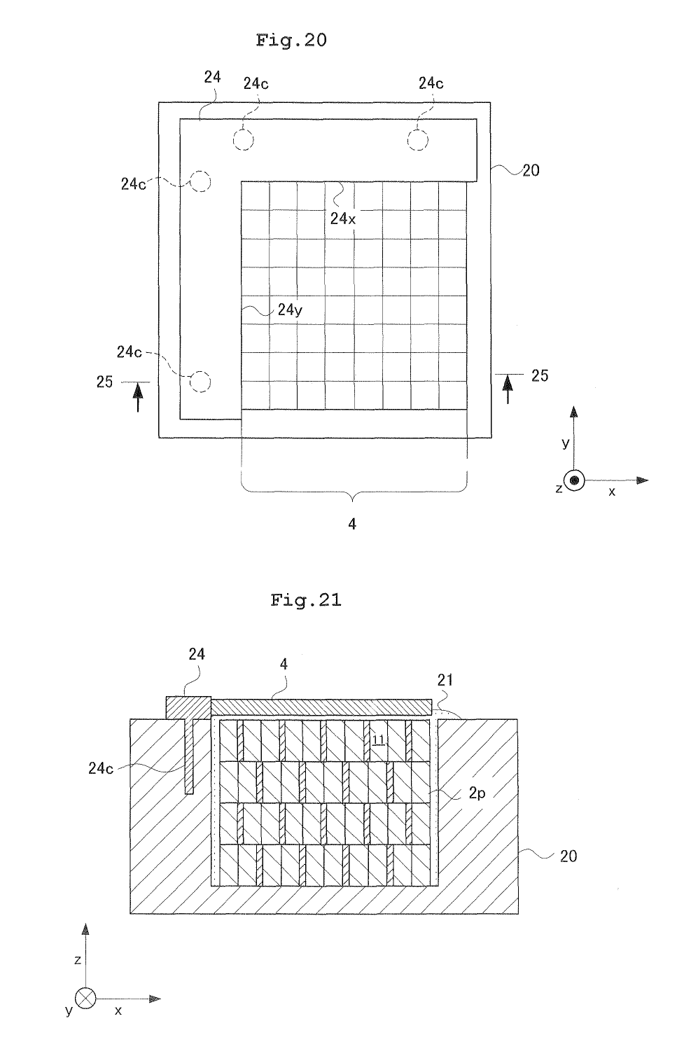

Next, as shown in FIG. 19, the light guide 4 is placed so as to cover the upper surface of the temporary assembly 2p that is exposed from the recess 20a of the receptacle for joint 20. Taking into consideration that the temporary assembly 2p sinks into the optical adhesive 21, the upper surface of the temporary assembly 2p is to be penetrated with the optical adhesive 21. When the light guide 4 is placed under this state so as to cover the upper surface of the temporary assembly 2p, a film of the optical adhesive 21 is interposed between one surface of the light guide 4 directed downward vertically and the upper surface of the temporary assembly 2p. Here, the position of the temporary assembly 2p with respect to the light guide 4 is determined with the light guide jig 24. Specifically, as shown in FIG. 20, the light guide 4 placed in the receptacle for joint 20 slides so as to contact one surface 24x extending in the x-direction and the other surface 24y extending in the y-direction. Accordingly, the light guide 4 is guided so as to contact the light guide jig 24 in the x-direction and the y-direction. Taking into consideration that the light guide jig 24 has the L-shape, the light guide 4 is relatively positioned en bloc with respect to the temporary assembly 2p in both x-direction and y-direction. The x-direction and the y-direction correspond to the first direction and the second direction, respectively, in this invention.

FIG. 21 is a sectional view of the receptacle for joint on arrow at a position of numeral 25 in FIG. 20 when cutting thereof. As shown in FIG. 21, the relative position of the light guide 4 and the temporary assembly 2p is determined with the light guide jig 24. FIG. 21 is a sectional view in the zx-plane. Embodiment 1 has a similar yz-plane in its sectional view.

<Second Hardening Resin Hardening Step S10>

Subsequently, the optical adhesive 21 hardens. Consequently, the scintillator 2 is formed inside the recess 20a having the scintillation counter crystals coupled three-dimensionally. Simultaneously, the optical adhesive 21 between the scintillator 2 and the light guide 4 also hardens. As a result, the scintillator 2 and the light guide 4 are to be joined and coupled optically. As noted above, with the method of manufacturing the radiation detector 1 according to Embodiment 1, the scintillator 2 and the light guide 4 are already coupled optically.

<Coupling Step S11>

At the time the light guide 4 and the scintillator 2 are joined, the light guide jig 24 is removed from the receptacle for joint 20. As a result, the light guide 4 is exposed on the upper surface of the receptacle for joint 20. Then, the scintillator 2 is drawn out from the recess 20a of the receptacle for joint 20 using the light guide 4 as a handle. The light detector 3 approaches the light guide 4 such that the light guide 4 is sandwiched between the light detector 3 and the scintillator 2 to optically couple both 3 and 4 via the optical adhesive. As mentioned above, the radiation detector 1 according to Embodiment 1 is completed.

With the configuration of Embodiment 1 as mentioned above, the method of manufacturing the radiation detector 1 may be provided in which the step of hardening the optical adhesive 21 and the step of optically coupling the scintillator 2 and the light guide 4 are performed en bloc. In other words, the scintillator 2 of the configuration in Embodiment 1 is manufactured by forming the temporary assembly 2p having the scintillation counter crystals 11 arranged therein, and penetrating gaps between the scintillation counter crystals 11 with the optical adhesive 21, and then hardening it. According to the configuration in Embodiment 1, the scintillator 2 is not manufactured merely by hardening the optical adhesive 21, but the light guide 4 is placed so as to cover one surface of the temporary assembly 2p that sinks into the optical adhesive 21 prior to hardening. As a result, the optical adhesive 21 is to be interposed between the one surface of the temporary assembly 2p and the light guide 4. According to the configuration in Embodiment 1, the optical adhesive 21 hardens while the light guide 4 is placed on the temporary assembly 2p. Consequently, the optical adhesive 21 that penetrates between the scintillation counter crystals 11 constituting the temporary assembly 2p hardens to join the scintillation counter crystals 11 to one another. Moreover, the optical adhesive 21 interposed between one surface of the temporary assembly 2p and the light guide 4 hardens, thereby joining the scintillator 2 and the light guide 4. Therefore, the foregoing configuration in Embodiment 1 may realize manufacturing of the radiation detector 1 with no complicated process of forming the scintillator 2 and the light guide 4 individually and coupling them with the optical adhesive.

### Embodiment 2

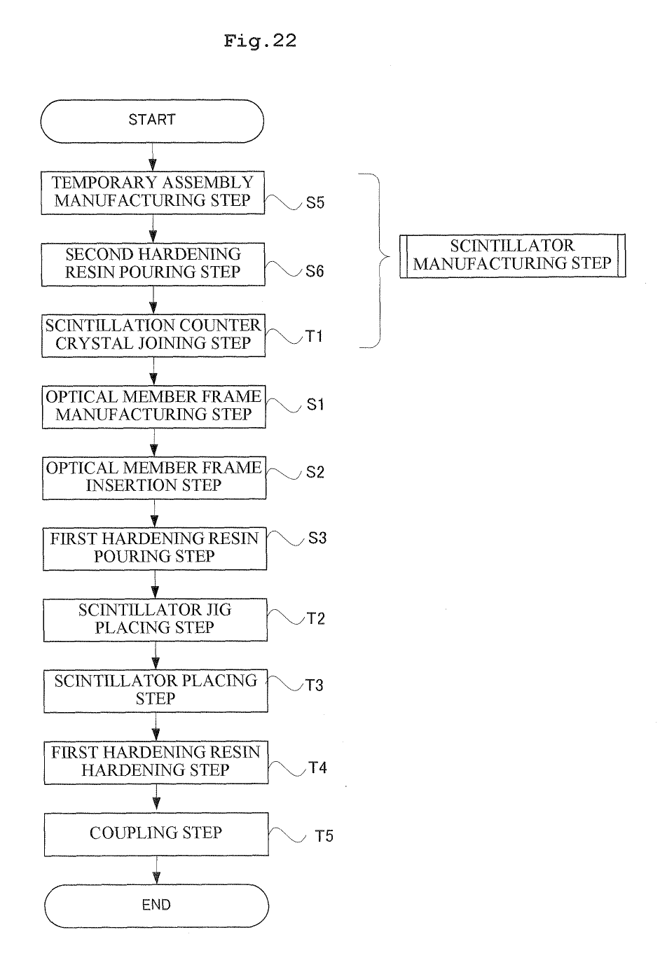

Next, description will be given of a configuration in Embodiment 2. Embodiment 2 differs from Embodiment 1 in manufacturing in advance of the scintillator 2. FIG. 22 is a flow chart showing a method of manufacturing a radiation detector according to Embodiment 2. The configuration of Embodiment 2 includes the step of manufacturing the scintillator. The same steps proceed as the step S5 of manufacturing the temporary assembly and the step S6 of pouring the second hardening resin in Embodiment 1 upon manufacturing of this scintillator. Thus, the explanation thereof is to be omitted. In Embodiment 2, at the time the temporary assembly 2p is placed in the receptacle for joint 20, the optical adhesive 21 (the second hardening resin) hardens, and the scintillator 2 having the scintillation counter crystals 11 joined to one another is removed from the receptacle for joint 20. This unique step in Embodiment 2 is referred to as the step T1 of joining the scintillation counter crystals. Here, at the time the scintillator 2 is removed from the receptacle for joint 20, the excessive film optical adhesive 21 is removed that adheres to each surface of the scintillator 2. In this way, the scintillator 2 is firstly manufactured in Embodiment 2. That is, the step S5 of manufacturing the foregoing temporary assembly, the step S6 of pouring the second hardening resin, and the step T1 of joining the scintillation counter crystals correspond to the scintillator manufacturing step according to this invention.

Next, the light guide 4 is to be manufactured. In this situation, the same steps proceed as the optical member frame manufacturing step S1, the optical member frame insertion step S2, and the first hardening resin pouring step S3 described in Embodiment 1. The explanation thereof is to be omitted. Here, the optical member frame 6 is inserted into an opening 27a of the mold 27 (corresponding to the mold 7 in Embodiment 1), and sinks into the thermosetting resin 8 prior to hardening.

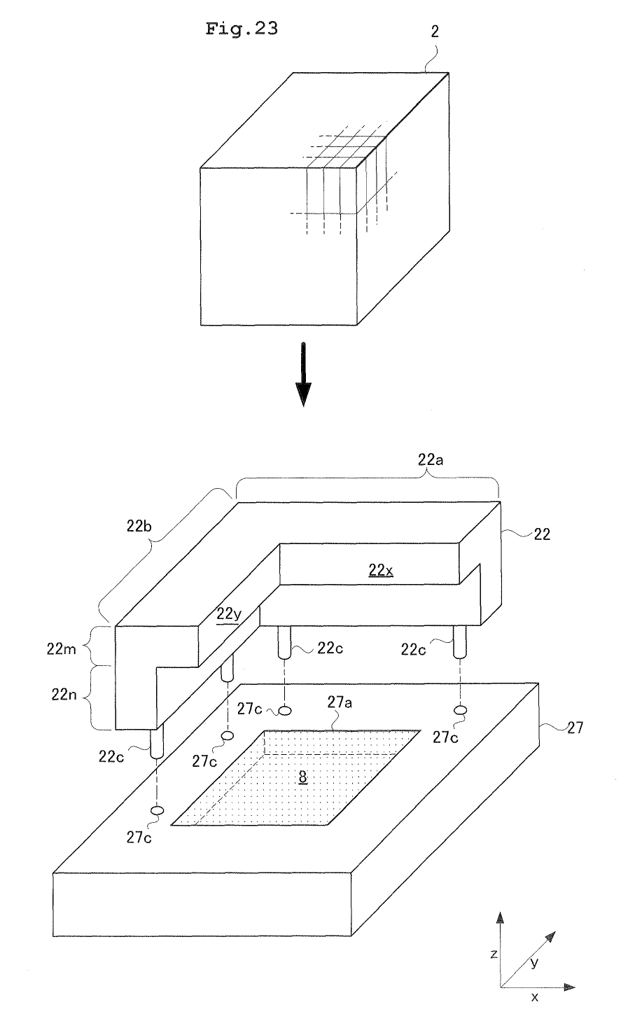

Now, description will be given of the mold 27 according to Embodiment 2. FIG. 23 is a perspective view showing the method of manufacturing the radiation detector according to Embodiment 2. As shown in FIG. 23, the mold 27 with a rectangular opening 27a has on its front surface two or more slits 27c. The slits 27c are arranged in the L-shape along two sides of the opening 27a that is rectangular seen in the vertical direction.

<Scintillator Jig Placing Step T2>

Next, as shown in FIG. 23, the scintillator jig 22 is placed on the mold 27. The scintillator jig 22 is a jig having a first portion 22a extending in the x-direction and a second portion 22b extending in the y-direction that are coupled in the L-shape. Consequently, the scintillator jig 22 is L-shaped seen in the z-direction (the vertical direction.) The first portion 22a and the second portion 22b of the scintillator jig have nibs 22c that extend downward in the vertical direction. Upon placing of the scintillator jig 22 in the mold 27, the nibs 22c are fitted into the slits 27c on the upper end of the mold 27.

The scintillator jig 22 is divided into an upper region 22m and a lower region 22n that are stacked in the z-direction. The upper region 22m is provided on the upper end side of the scintillator jig 22. The upper region 22m has a first surface 22x extending in the x-direction and a second surface 22y extending in the y-direction that contact the scintillator 2. On the other hand, the lower region 22n is provided on the lower end side having nibs 22c provided thereon, and has a cut-out with a portion that contacts the scintillator 2 being cut out in an L-shape. The cut-out is provided for suppressing penetrating of the thermosetting resin 8 that covers the opening 27a of the mold 27 between the scintillator jig 22 and the mold 27.

<Scintillator Placing Step T3>

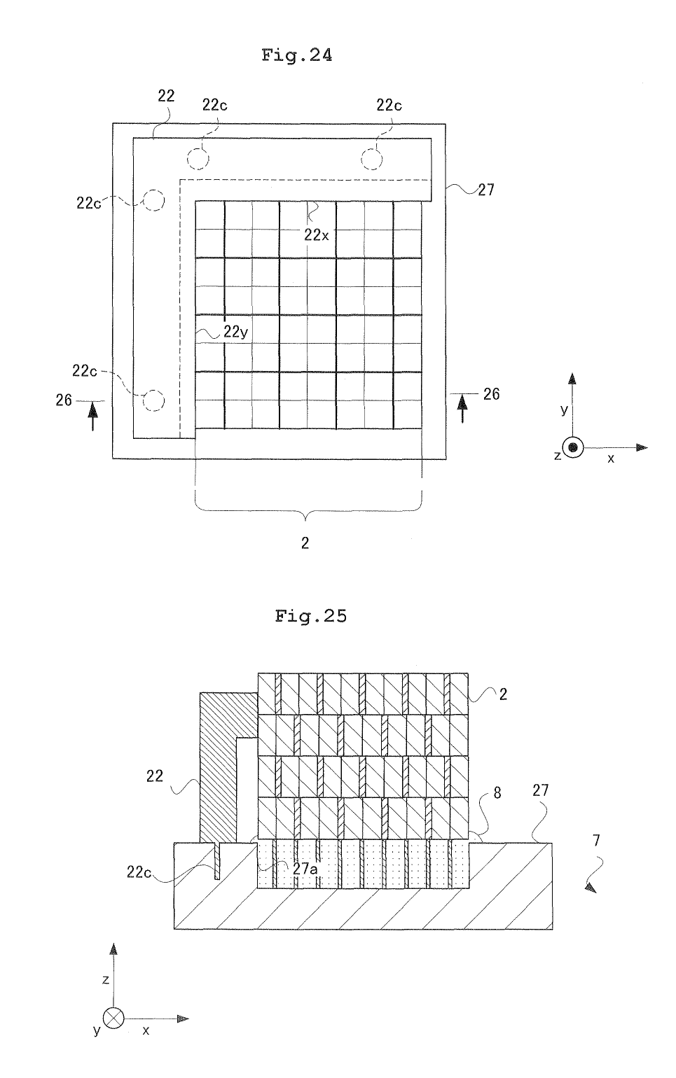

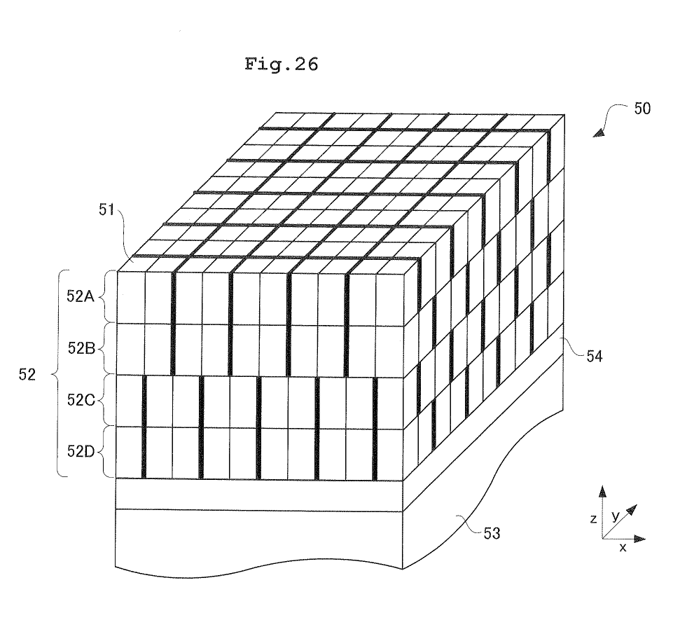

Next, the scintillator 2 is placed so as to cover the opening 27a of the mold 27, whereby the thermosetting resin 8 is interposed between the scintillator 2 and the light guide 4. Here, as shown in FIG. 24, the scintillator jig 22 positions the light guide 4 with respect to the scintillator 2. Specifically, the light guide 4 placed on the mold 27 slides to guide the scintillator 2 so as to contact each of the first surface 22x as the zx-plane of the scintillator jig 22 and the second surface 22y as the yz-plane in the x-direction and the y-direction, respectively. Taking into consideration that the scintillator jig 22 has the L-shape, the light guide 4 is relatively positioned en bloc with respect to the scintillator 2 in both x-direction and y-direction. The x-direction and the y-direction correspond to the first direction and the second direction, respectively, in this invention.

<First Hardening Resin Hardening Step T4>

Next, the thermosetting resin 8 hardens. Accordingly, the light guide 4 that receives light is manufactured inside the opening 27a. Simultaneously, the thermosetting resin 8 interposed between the scintillator 2 and the light guide 4 hardens, thereby optically joining and coupling the scintillator 2 and the light guide 4. In this way, with the method of manufacturing the radiation detector 1 according to Embodiment 2, the scintillator 2 and the light guide 4 are already coupled optically when the light guide 4 is manufactured.

FIG. 25 is a sectional view of the receptacle for joint on arrow at a position of numeral 26 in FIG. 24 when cutting thereof. As shown in FIG. 25, the relative position of the scintillator 2 and the opening 27a is determined with the scintillator jig 24.

<Coupling Step T5>

At the time the light guide 4 and the scintillator 2 are joined, the scintillator jig 22 is removed from the mold 27. As a result, the scintillator 2 is exposed on the upper surface of the mold 27. Then, the light guide 4 is drawn out from the opening 27a of the mold 27 using the scintillator 2 as a handle. The light detector 3 approaches the light guide 4 such that the light guide 4 is sandwiched between the light detector 3 and the scintillator 2 to optically couple both 3 and 4 via the optical adhesive. As mentioned above, the radiation detector 1 according to Embodiment 2 is completed.

According to Embodiments 1 and 2 as noted above, both steps of manufacturing the scintillator 2 and the light guide 4 include the step of hardening the hardening resin. Giving attention to this, Embodiments 1 and 2 have a configuration of manufacturing either the light guide 4 or the scintillator 2 and then placing either the manufactured scintillator 2 or the light guide 4 on the incomplete scintillator 2 or light guide 4. Such configuration allows one surface of the light guide 4 or the scintillator 2 to be penetrated with the hardening resin prior to hardening. When the hardening resin hardens under this state, the hardening resin that penetrates the one surface of the scintillator 2 or the light guide 4 is to harden, which results in joining of the light guide 4 and the scintillator 2. As noted above, the method of manufacturing the radiation detector 1 may be provided in which the step of hardening the hardening resin to manufacture the scintillator 2 or the light guide 4, and the step of optically coupling the scintillator 2 and the light guide 4 are performed en bloc. Therefore, the radiation detector 1 may be manufactured with no complicated process of forming the scintillator 2 and the light guide 4 individually and coupling them with the optical adhesive.

This invention is not limited to the foregoing configurations, but may be modified as follows.

(1) In each of the foregoing embodiments, the scintillation counter crystal is composed of LYSO. Alternatively, the scintillation counter crystal may be composed of another materials, such as GSO (Gd₂SiO₅), may be used in this invention. According to this modification, a method of manufacturing a radiation detector may be provide that allows provision of a radiation detector of low price.

(2) In each of the foregoing embodiments, the scintillator 2 has four scintillation counter crystal layers. This invention is not limited to this embodiment.

For instance, the scintillator formed of one scintillation counter crystal layer may be applied to this invention. Moreover, the scintillation counter crystal layer may be freely adjusted in number depending on applications of the radiation detector.

(3) The light detector in each of the foregoing embodiments is formed of the photomultiplier tube. This invention is not limited to this embodiment. A photodiode or an avalanche photodiode, etc. may be used instead of the photomultiplier tube.

(4) In each of the foregoing embodiments, the first optical member and the second optical member that constitute the light guide are formed of a reflector that reflects fluorescence. This invention is not limited to this embodiment. A material of the first plate may be selected from one of a material that reflects light, a material that absorbs light, and a material that transmits light. Likewise, a material of the optical member may be selected from one of a material that reflects light, a material that absorbs light, and a material that transmits light. According to this modification, the first optical member and the second optical member may freely vary in material depending on applications of the radiation detector.

### INDUSTRIAL UTILITY

As described above, this invention is suitable for a radiation detector for use in a medical field.

1. A method of manufacturing a radiation detector having a scintillator with scintillation crystal layers converting radiation into fluorescence being joined to one another, a light guide that receives fluorescence, and a light detector that detects fluorescence optically coupled to one another, comprising the steps of:
manufacturing the light guide through hardening of a first hardening resin;
forming a temporary assembly prior to joining of the scintillation counter crystals through arrangement of the scintillation counter crystals;
arranging the temporary assembly in a recess of a receptacle for joint that is formed toward a vertical direction;
pouring a second hardening resin prior to hardening into the recess to sink the temporary assembly thereinto;
placing the light guide Over one surface of the temporary assembly exposed from the recess, and interposing the second hardening resin in a gap between the light guide and the one surface of the temporary assembly;
hardening the second hardening resin to manufacture the scintillator with the scintillation counter crystals joined to one another and to join the scintillator and the light guide; and
optically coupling the light guide and the light detector.

2. The method of manufacturing the radiation detector according to claim 1, further comprising the step of placing a light guide jig that places the light guide jig for determining a relative position of the light guide and the temporary assembly in the receptacle for joint.

3. The method of manufacturing the radiation detector according to claim 2, wherein the light guide jig has an L-shape that extends in a first direction and a second direction seen from the vertical direction, and determines a relative position of the light guide and the temporary assembly with respect to the first direction and the second direction.

4. A method of manufacturing a radiation detector having a scintillator with scintillation crystal layers converting radiation into fluorescence being joined to one another, a light guide that receives fluorescence, and a light detector that detects fluorescence optically coupled to one another, comprising the steps of:
manufacturing the scintillator by joining the scintillation counter crystals to one another through hardening of a second hardening resin;
pouring a first hardening resin prior to hardening to a vertical opening of a mold;
placing the scintillator so as to cover the opening, whereby the first hardening resin penetrates one surface of the scintillator directed downward in the vertical direction;
hardening the first hardening resin to manufacture the light guide and to join the scintillator and the light guide; and
optically coupling the light guide and the light detector.

5. The method of manufacturing the radiation detector according to claim 4, further comprising the step of placing a scintillator jig on the mold for determining a relative position of the scintillator and the light guide.

6. The method of manufacturing the radiation detector according to claim 5, wherein the scintillator jig has an L-shape that extends in a first direction and a second direction seen from the vertical direction, and determines a relative position of the scintillator and the light guide with respect to the first direction and the second direction.

7. The method of manufacturing the radiation detector according to claim 1, wherein the scintillator has the scintillation counter crystals arranged in a three-dimensional array.

8. The method of manufacturing the radiation detector according to claim 1, wherein the first hardening resin and the second hardening resin are selected from materials different from each other.

9. The method of manufacturing the radiation detector according to claim 2, wherein the scintillator has the scintillation counter crystals arranged in a three-dimensional array.

10. The method of manufacturing the radiation detector according to claim 3, wherein the scintillator has the scintillation counter crystals arranged in a three-dimensional array.

11. The method of manufacturing the radiation detector according to claim 4, wherein the scintillator has the scintillation counter crystals arranged in a three-dimensional array.

12. The method of manufacturing the radiation detector according to claim 5, wherein the scintillator has the scintillation counter crystals arranged in a three-dimensional array.

13. The method of manufacturing the radiation detector according to claim 6, wherein the scintillator has the scintillation counter crystals arranged in a three-dimensional array.

14. The method of manufacturing the radiation detector according to claim 2, wherein the first hardening resin and the second hardening resin are selected from materials different from each other.

15. The method of manufacturing the radiation detector according to claim 3, wherein the first hardening resin and the second hardening resin are selected from materials different from each other.

16. The method of manufacturing the radiation detector according to claim 4, wherein the first hardening resin and the second hardening resin are selected from materials different from each other.

17. The method of manufacturing the radiation detector according to claim 5, wherein the first hardening resin and the second hardening resin are selected from materials different from each other.

18. The method of manufacturing the radiation detector according to claim 6, wherein the first hardening resin and the second hardening resin are selected from materials different from each other.

19. The method of manufacturing the radiation detector according to claim 7, wherein the first hardening resin and the second hardening resin are selected from materials different from each other.
